(19) United States
(12) Patent Application Publication
(10) Pub. No.: US 2024/0337804 A1
(43) Pub. Date: Oct. 10, 2024

(54) METHOD OF MANUFACTURING OPTICAL FIBRE RIBBON

(71) Applicant: Sterlite Technologies Limited, Gurugram (IN)

(72) Inventors: Marquesha McVea, Lugoff, SC (US); Steven Beasley, Lugoff, SC (US)

(21) Appl. No.: 18/601,345

(22) Filed: Mar. 11, 2024

Related U.S. Application Data
(60) Provisional application No. 63/494,530, filed on Apr. 6, 2023.

(51) Int. Cl. G02B 6/44

(52) U.S. Cl. CPC G02B 6/448

(57) ABSTRACT

A method (200) for manufacturing a unitary optical fibre ribbon (100) is provided. The method (200) comprises arranging (210) a plurality of sets (110) of optical fibres (112), disposing (220) a single resin coat (130) on a pair of parallel surfaces (120) to sandwich the arranged plurality of sets (110) of optical fibres, providing (230) at least one split-inducing region (150) between at least one of pairs of adjacent sets (110a, 110b), and curing (240) the single resin coat (130) thereby forming a unitary optical fibre ribbon (100). Each of the plurality of sets (110a, 110b, 110c) has a plurality of optical fibres (112a, 112b, 112c). The plurality of sets (110) is arranged for joining together to form the unitary optical fibre ribbon (100). The arranged plurality of sets (110) has the pair of surfaces (120) substantially parallel to each other.

### CROSS-REFERENCE TO RELATED APPLICATIONS

This application claims the benefit of U.S. provisional Application No. 63/494,530 titled “METHOD OF MANUFACTURING OPTICAL FIBER RIBBON” filed by the applicant on 6 Apr. 2023, which is incorporated herein by reference in its entirety.

### FIELD OF THE INVENTION

The present invention relates to optical fibre ribbons and more particularly to methods of manufacturing optical fibre ribbon.

### BACKGROUND OF THE INVENTION

Fibre optic cables (i.e., optical cables) are commonly used for data transfer and communications in a variety of networking applications. The typical fibre optic cables use loose optical fibres or optical fibre ribbons. Use of optical fibre ribbons provide an advantage of easy splicing. A typical optical fibre ribbon has 12 optical fibres. With the ever increasing demand for higher fibre count ribbons, it is becoming challenging to increase number of optical fibres in a ribbon while allowing easy mid-spanning during deployment, and developing a low-cost high-yield manufacturing process.

There are a few known methods to manufacture 24 fibre flat ribbons. In one such known method, a typical manufacturing method is used with more than 12 optical fibres. In this method, more than 12 optical fibres are placed in parallel and covered with a coating to form a ribbon. In another known method, two 12-fibre flat ribbons are joined together by heat shrinking a thermoplastic wire between the two standard 12-fibre flat ribbons. In yet another known method, two 12-fibre flat ribbons are joined together by coating with an additional soft layer on top of the ribbons.

However, above prior art methods suffer from one or more of the following limitations. One or more of the above methods does not allow manufacturing a ribbon that allows easy mid-spanning. Moreover, one or more of the above methods require multiple pass of manufacturing process that increases cost, increases the process time, reduces the capacity of production, and so forth.

Therefore, there is a need for a method to manufacture a flat ribbon that overcomes one or more limitation associated with the prior art.

### SUMMARY OF THE INVENTION

In one aspect, a method for manufacturing a unitary optical fibre ribbon is provided. The method comprises arranging a plurality of sets of optical fibres so that the arranged optical fibres have a pair of surfaces substantially parallel to each other, disposing a resin coat (110ar, 110br) on the pair of parallel surfaces to sandwich the arranged plurality of optical fibres (112a, 112b) between the resin coat (110ar, 110br), sequentially disposing a resin coat (110r) to sandwich the plurality of sets (110a, 110b) of optical fibers and curing the resin coat (110r) thereby forming a unitary optical fibre ribbon. Each of the plurality of sets has a plurality of optical fibres. The plurality of sets are being arranged for joining together to form the unitary optical fibre ribbon. The arranged plurality of sets has the pair of surfaces substantially parallel to each other. The step of disposing the resin coat (110r) comprises providing at least one split-inducing region 150 between at least one of pairs of adjacent sets in the plurality of the sets of optical fibres.

In an embodiment, the method comprises forming the each of the plurality of sets 110a-b by laying the plurality of optical fibres 112a-b in a substantially parallel manner to one another prior to arranging the plurality of sets of optical fibres.

In an embodiment, the step of disposing comprises coating the resin coat (110r) over the pair of surfaces of the arranged plurality of sets (110a-b) of optical fibres.

In another aspect, the method of manufacturing the unitary ribbon comprises arranging the plurality of sets of optical fibres, disposing the resin coat (110ar, 110br) on the pair of parallel surfaces to sandwich the arranged plurality of sets of optical fibres between the resin coat (110ar, 110br) and partially curing the resin coat (110ar, 110br). Subsequently, disposing the resin coat (110r) over the resin coat and providing one or more split-inducing regions between the at least one of pairs of adjacent sets of optical fibres in the plurality of the sets (110a-b) of optical fibres (112a-b), wherein the one or more split-inducing regions (150) at least partially extend along length of the unitary ribbon (100).

In an embodiment, the step of arranging the plurality of sets of optical fibres comprises arranging the plurality of optical fibres of the each set such that centre-to-centre distance between adjacent optical fibres in the each set is a first distance. The step of arranging further comprises arranging the plurality of sets such that centre-to-centre distance between pair of adjacent optical fibres of the at least one of pairs adjacent sets of optical fibres is a second distance. The second distance is greater than the first distance.

In an embodiment, the step of curing comprises curing the resin coat (110ar, 110br) to a first predetermined percentage value, wherein: curing a resin coat (110r) of the single resin coat to a second predetermined percentage value. In an embodiment, the first predetermined percentage value is greater than the second predetermined percentage value. The difference is in the range of 5 to 30 percentage points.

In an embodiment, the step of curing is performed by providing an environment of the heterogeneous controlled gas mixture with Oxygen content in the range of 1000-2000 ppm.

### BRIEF DESCRIPTION OF THE DRAWINGS

The method and system are illustrated in the accompanying drawings, throughout which like reference letters indicate corresponding parts in the various drawings. The invention herein will be better understood from the following description with reference to the drawings, in which:

FIG. 1A is a perspective view of a unitary optical fibre ribbon, in accordance with an embodiment of the present invention.

FIG. 1B is a perspective sectional view of the unitary optical fibre ribbon, in accordance with an embodiment of the present invention.

FIGS. 2A and 2B are perspective sectional views of the unitary optical fibre ribbon illustrating different number of optical fibres and number of sets of plurality of optical fibres, in accordance with various embodiment of the present invention.

FIG. 3 is a flowchart depicting a method for manufacturing the unitary optical fibre ribbon, in accordance with an embodiment of the present invention.

FIG. 4 is a flowchart depicting the method for manufacturing the set of optical fibers, in accordance with another embodiment of the present invention.

FIG. 5 is an isometric cross sectional view of the unitary ribbon illustrating the distance between adjacent optical fibers, in accordance with another embodiment of the invention.

FIG. 6 is an isometric cross sectional view of the unitary ribbon illustrating the variable thickness of the resin coat between adjacent sets in the unitary ribbon, in accordance with another embodiment of the invention.

FIG. 7 is an isometric cross sectional view of the unitary ribbon illustrating partially extending grooves in the unitary ribbon, in accordance with another embodiment of the invention.

FIG. 8 is a block diagram depicting the method for manufacturing the unitary optical fibre ribbon, in accordance with another embodiment of the present invention.

### DETAILED DESCRIPTION

In the following detailed description of the invention, numerous specific details are set forth in order to provide a thorough understanding of the invention. However, it will be obvious to a person skilled in the art that the invention may be practiced with or without these specific details. In other instances, well known methods, procedures and components have not been described in detail so as not to unnecessarily obscure aspects of the invention.

Furthermore, it will be clear that the invention is not limited to these implementations only. Numerous modifications, changes, variations, substitutions and equivalents will be apparent to those skilled in the art, without parting from the scope of the invention. The accompanying drawings are used to help easily understand various technical features and it should be understood that the implementations presented herein are not limited by the accompanying drawings. As such, the present disclosure should be construed to extend to any alterations, equivalents and substitutes in addition to those which are particularly set out in the accompanying drawings.

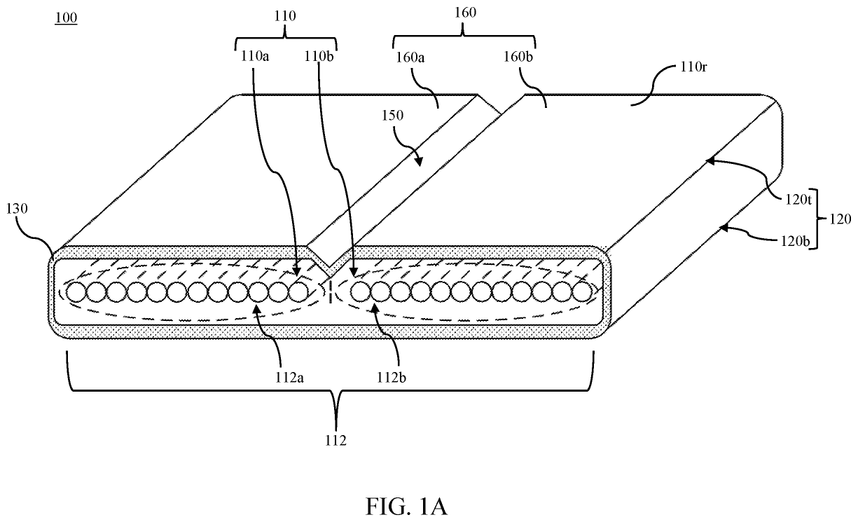

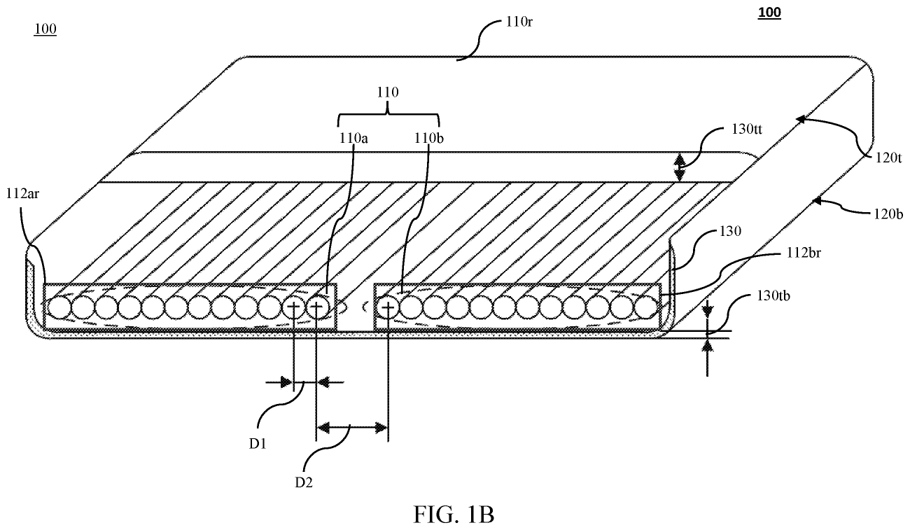

FIG. 1A and FIG. 1B are perspective views of a unitary optical fibre ribbon 100, in accordance with an embodiment of the present invention. The unitary ribbon 100 comprises a plurality of sets 110 of optical fibres 112, a resin coat 110ar, 110br, a subsequent resin coat 110r and at least one split-inducing region 150 between at least one of pairs of adjacent sets 110a-b of optical fibres in the plurality of the sets 110. As an example, the plurality of sets 110 includes a set 110a, and a set 110b. The number of actual sets may be more and vary. Each of the sets 110 has a plurality of optical fibres 112. For example, the set 110a has 12 optical fibres 112a, the set 110b has 12 optical fibres 112b. The plurality of sets 110 is arranged for joining together to form the unitary optical fibre ribbon 100. In an embodiment, the resin coat (110ar, 110br) and the resin coat (110r) is a UV matrix specific UV acrylate or other compounded UV acrylate thermoset material, where the cross linking is achieved at the range of 50-100%.

The arranged plurality of sets 110 has a pair of surfaces 120, including a top surface 120t and a bottom surface 120b substantially parallel to each other. The resin coat (110ar, 110br) sandwiches the plurality of optical fibers (112a, 112b) of the plurality of sets (110a, 1120b) and the subsequent resin coat (110r) sandwiches the plurality of sets (110a, 110b) of the optical fibers 112. At least one split-inducing region 150 is provided in the resin coat (110r) between at least one of pairs of adjacent sets (110a and 110b). The resin coat (112a, 112b) and the resin coat (110r) are disposed and cured according to a method 200 to form the unitary ribbon 100, in accordance with various embodiments of the invention. In an embodiment, the resin coat (110ar, 110br) may be applied on one side of the plurality of optical fibers (112a, 112b). In another embodiment, the resin coat (110ar, 110br) may be applied on both sides of the plurality of optical fibers (112a, 112b). In an embodiment, the resin coat (110r) may be applied on one side of the plurality of sets (110a, 110b). In another embodiment, the resin coat (110r) may be applied on both sides of the plurality of sets (110a, 110b). The resin coat 110ar-br to make the plurality of optical fibers sets 110a-b of the optical fibers 112a-b and the resin coat 110r to make the optical fiber ribbon 100 have identical composition.

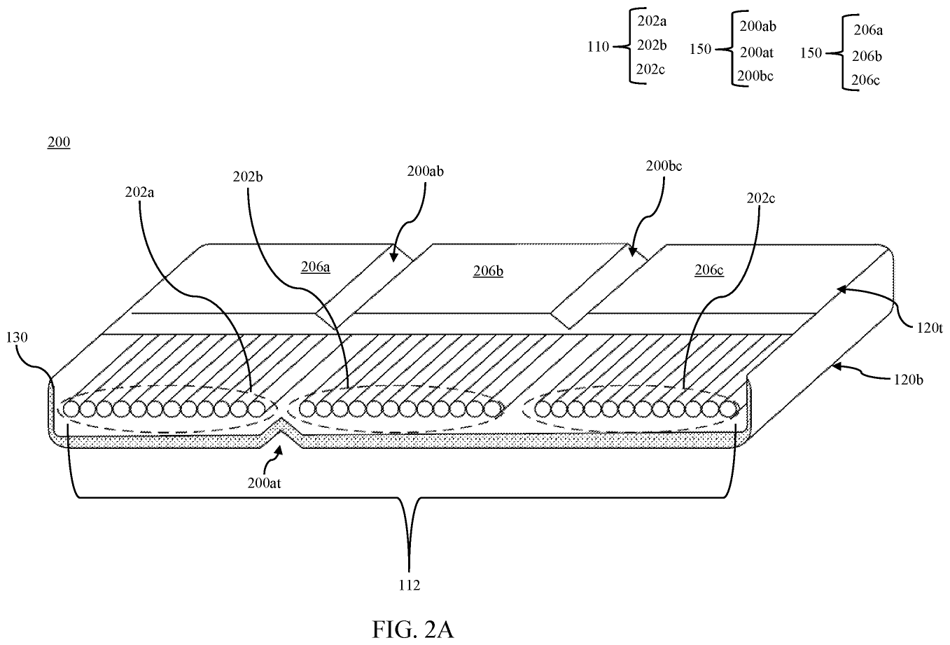

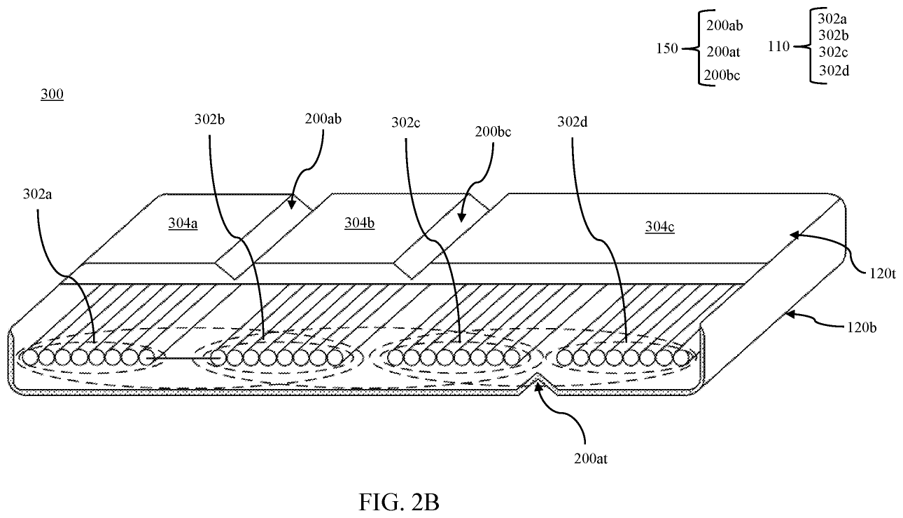

FIG. 2A and FIG. 2B are perspective sectional views of the unitary optical fibre ribbon 200, in accordance with various embodiment of the present invention. FIG. 2A is a perspective sectional view of the unitary optical fibre ribbon 100, in accordance with an embodiment of the present invention. In an embodiment as shown in FIG. 2A, The unitary ribbon 200 is provided with three split-inducing regions 150 (200ab, 200bc, 200at) between the adjacent sets 110 (202a-c) c: 200ab, 200bc at the top surface 120t and 200at on the bottom surface 120b.

FIG. 2B is a perspective view of the unitary optical fibre ribbon 300, in accordance with an embodiment of the present invention. In an embodiment as shown in FIG. 2B, the unitary ribbon 300 has four sets 302a, 302b, 302c and 302d and three split inducing regions 200ab, 200at and 200bc: the split-inducing region 150at on the bottom surface 120b between the sets 302c and 302d and split-inducing regions 200ab, 200bc on the top surface 120t between the sets 302a-b and 302b-c respectively.

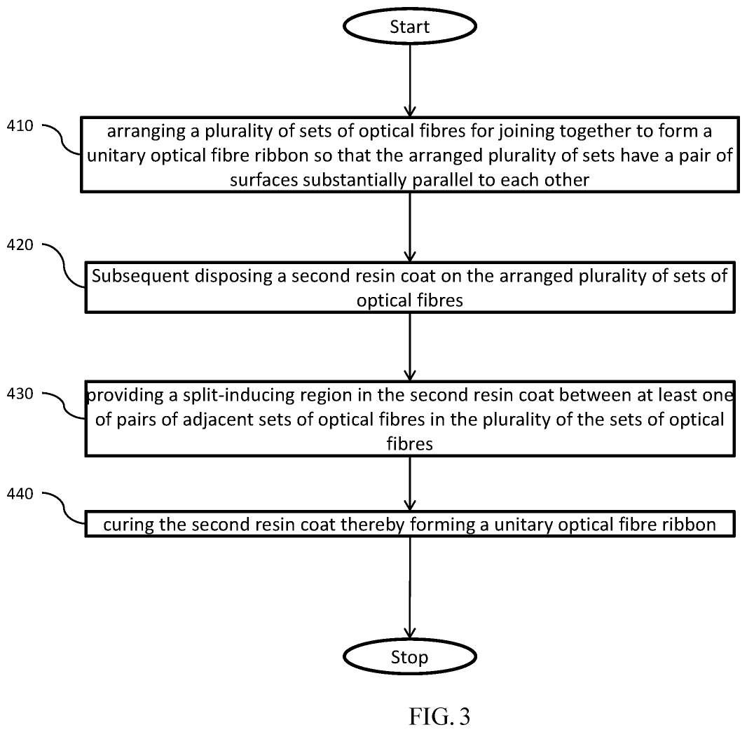

FIG. 3 is a flowchart depicting the method 400 for manufacturing the unitary optical fibre ribbon 100, in accordance with an embodiment of the present invention. At step 410, arranging the plurality of sets 110 of optical fibres 112 for joining together to form the unitary optical fibre ribbon 100 so that centres of the plurality of optical fibers 112 of the arranged plurality of sets 110 substantially pass through a common plane. At step 420, disposing the resin coat (110r) to form the pair of parallel surfaces 120 to sandwich the arranged plurality of sets 110 of optical fibres between the resin coat (110r). At step 430, providing the at least one split-inducing region 150 between at least one of pairs of adjacent sets (110a and 110b or 110b and 110c) of optical fibres in the plurality of the sets 110 of optical fibres. Split inducing region 150ab is provided between the set 110a and the set 110b. Similarly, split inducing region 150bc may be provided between the set 110b and the set 110c.

At step 440, curing the resin coat (110r) thereby forming the unitary optical fibre ribbon 100. The step of curing includes exposing the resin coat (110r) to thermal or ultraviolet energy.

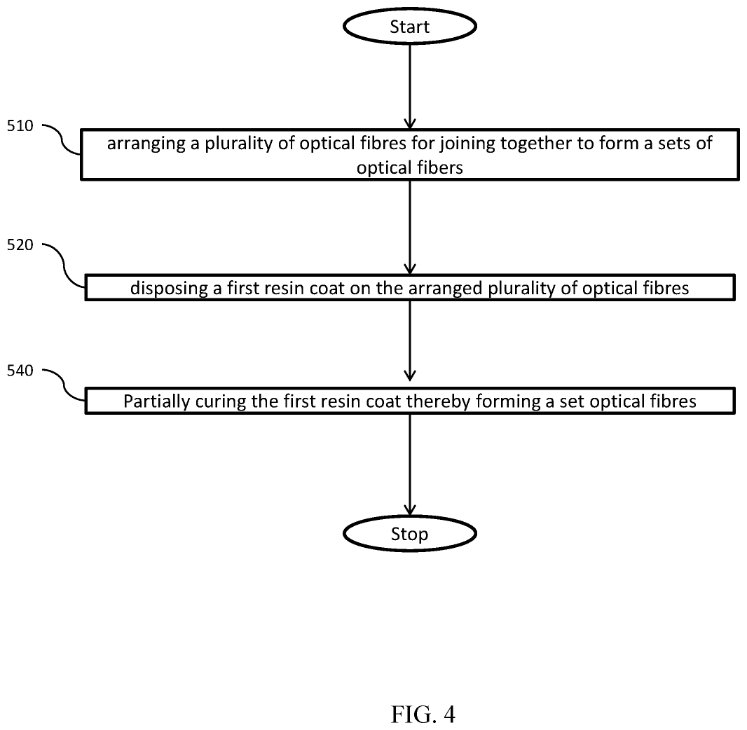

FIG. 4 is a flowchart depicting the method 500 for manufacturing a set 110 of a plurality of optical fibers 112, in accordance with another embodiment of the present invention. In an embodiment, the method 500 further includes step 510 wherein arranging a plurality of optical fibers 112 by laying the plurality of optical fibres 112 in a substantially parallel manner to one another, step 520 wherein disposing the resin coat (110ar, 110br) on the arranged plurality of optical fibers (112a, 112b) and step 540 wherein partially curing the resin coat to for the set of the optical fibers. For example, for forming the set 110a, the plurality of optical fibres 112a are laid in a substantially parallel manner to one another. Similarly, for forming the set 110b, the plurality of optical fibres 112b are laid in a substantially parallel manner to one another.

In an embodiment, a predetermined resilience time gap is ensured between the curing of the resin coat (110ar, 110br) and the resin coat (110r). In an embodiment, the predetermined resilience time gap is ensured by maintaining a predetermined fixed distance between a first curing station 320 for curing the resin coat (110ar, 110br) and a resin coat (110r) station 340 for curing the resin coat. In an embodiment, the predetermined resilience time gap is in the range of 0.12 to 1.2 seconds. The resilience time gap ensures that the resin coat has cured before reaching to the second curing station.

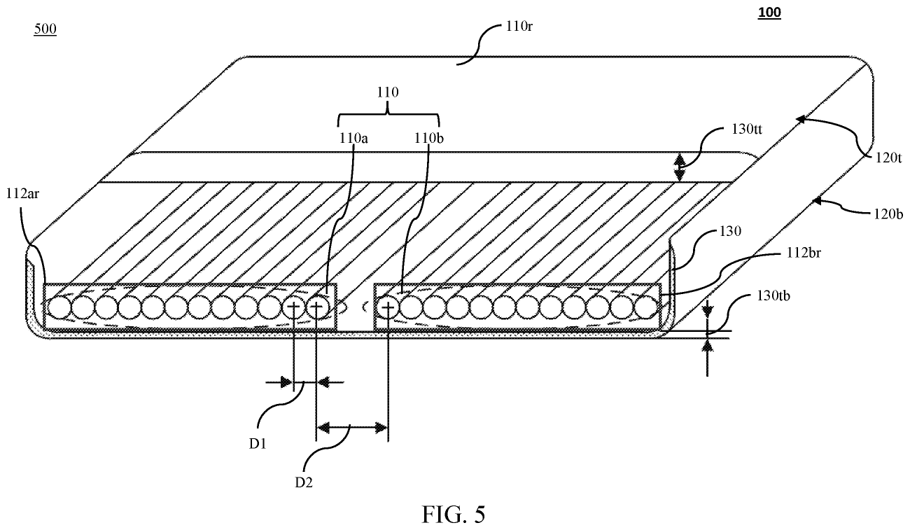

FIG. 5 is an isometric cross sectional view of the unitary ribbon 500 illustrating distance between the optical fibres 112 in the unitary ribbon 100, in accordance with another embodiment of the invention. For example, referring to FIG. 5, the first distance, ribbon pitch ‘D1’ between each of centres of the adjacent optical fibres 112a is same and is in the order of 250 microns. For example, in an embodiment, the distance ‘D1’ may be 180 microns, and in another embodiment, ‘D1’ may be 200 microns. The second distance ‘D2’ between the centres of the adjacent optical fibres in the set 110a and the set 110b is greater than the first distance ‘D1’. That is, the second distance, set pitch ‘D2’ between the optical fibre 112a adjacent to the optical fibre 112b is greater than the first distance ‘D1’. The set pitch (D2) is greater than the ribbon pitch (D1) by at least 5% of the diameter of the optical fiber 112.

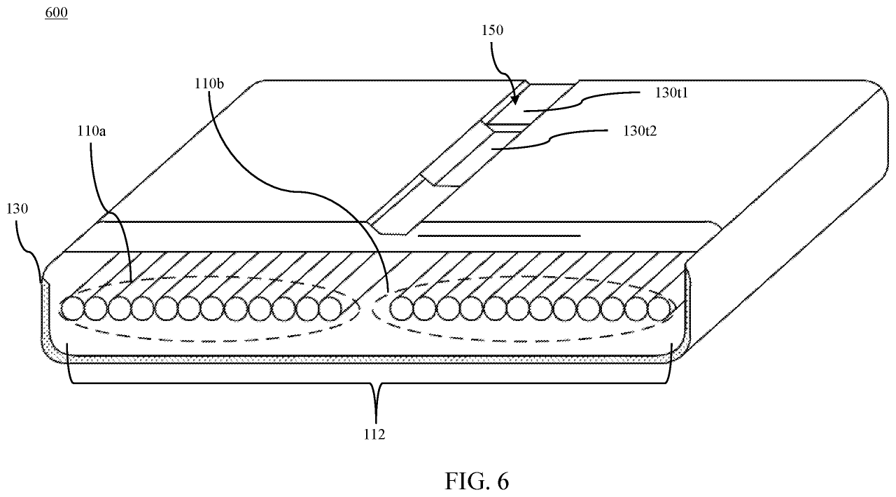

FIG. 6 is an isometric cross sectional view of the unitary ribbon 600 illustrating thickness of the resin coat 110r between adjacent sets 110 in the unitary ribbon 100, in accordance with an embodiment of the invention. As shown in FIG. 6, the resin coat thickness 130t1 of the resin coat 110r along length of the unitary ribbon 100 at the at least one split-inducing region 150.

As shown in FIG. 6, the resin coat thickness of the resin coat in the split inducing region 150 varies along length of the unitary ribbon 600. The resin coat thickness 130t2 of the resin coat 110r in the split inducing regions 150 and 150 is less than the resin coat 110r thickness 130t1 at only some of length portions along the length of the unitary ribbon 100.

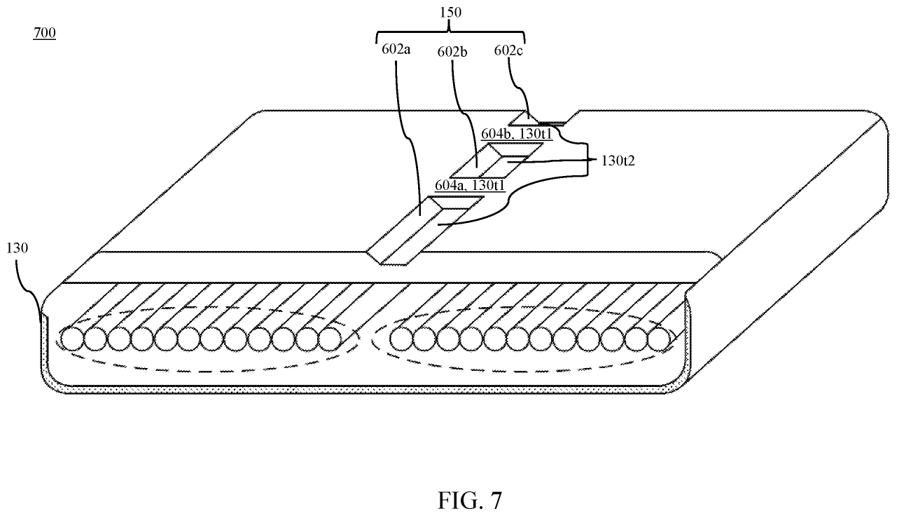

FIG. 7 is an isometric cross sectional view of the unitary ribbon illustrating the discontinuous formation of at-least one of the split-inducing regions 150 in the resin coat between adjacent sets 110 in the unitary ribbon 100, in accordance with another embodiment of the invention. In an embodiment, the step of disposing 420 comprises providing one or more grooves (150) between the at least one of pairs of adjacent sets (110a and 110b) of optical fibres in the plurality of the sets 110 of optical fibres 112. As shown in FIG. 7, the one or more grooves (150) at least partially extend along length of the unitary ribbon 100 as portions 602a-c. As illustrated, the split inducing region 150 at least partially extend along the length of the unitary optical fibre ribbon 700. The split inducing region 150 may have a penetration depth (D) in a range of 60 microns to 200 microns and a radius of curvature in a range of 0.01 millimetres (mm) to 0.04 mm. The unitary optical fibre ribbon 700 having the split inducing region 150 (i.e., a groove) with penetration depth of less than 60 microns will not be splitable by an external force in the range of 0.1 Newton to 0.5 Newton. The unitary optical fibre ribbon 700 having the split inducing region 150 (i.e., a groove) with penetration depth of more than 200 microns will not be sufficient mechanically robust to handle during manufacturing operations. The split inducing region 150 may have a penetration depth (D) in a range of 60 microns to 200 microns and a radius of curvature in a range of 0.01 millimetres (mm) to 0.04 mm. The unitary optical fibre ribbon 700 having the split inducing region 150 (i.e., a groove) with radius of curvature of less than 0.01 mm will not be splitable by an external force in the range of 0.1 Newton to 0.5 Newton. The unitary optical fibre ribbon 700 having the split inducing region 150 (i.e., a groove) with radius of curvature of greater than 0.04 mm will not be sufficient mechanically robust to handle during manufacturing operations.

Every individual ribbons with an edge thickness (112te) of 1-20 microns is passed through a second ribbon central section area in which the joining guide die is designed with a V-groove at the top and bottom of the joined section. The edge thickness is the thickness of resin coat 110ar, 110br material at the edge optical fiber of individual ribbon 112 and the outer side surface of the individual ribbon 112.

In an embodiment, the steps of making varying resin coat thickness 130t2 may include forming of intermittently placed grooves, forming of a groove with variable depth along the length or forming of two or more grooves with different depths along the length.

In an embodiment, the step of curing 240 of the unitary ribbon 100 is performed in two or more stages. A first stage curing is performed before the formation of the split-inducing region 150ab and subsequent stage curing is performed after the formation of the split-inducing region 150ab.

In an embodiment, the curing is performed by providing an environment of the heterogeneous controlled gas mixture with Oxygen content in the range of 1000-2000 ppm. The bond strength of the split-inducing region 150 between the sets 110 is controlled during inline ribbon processing with adding an heterogeneous process of controlled gas and UV radiation.

In an embodiment, the step of curing 240 is performed by providing an environment of the heterogeneous controlled gas mixture with Oxygen content in the range of 1000-2000 ppm. The bond strength of the split-inducing region 150 between the sets 110 is controlled during inline ribbon processing with adding an heterogeneous process of controlled gas mixture with 1000-20000 ppm of Oxygen range and more preferably in the range of 1000-2000 ppm.

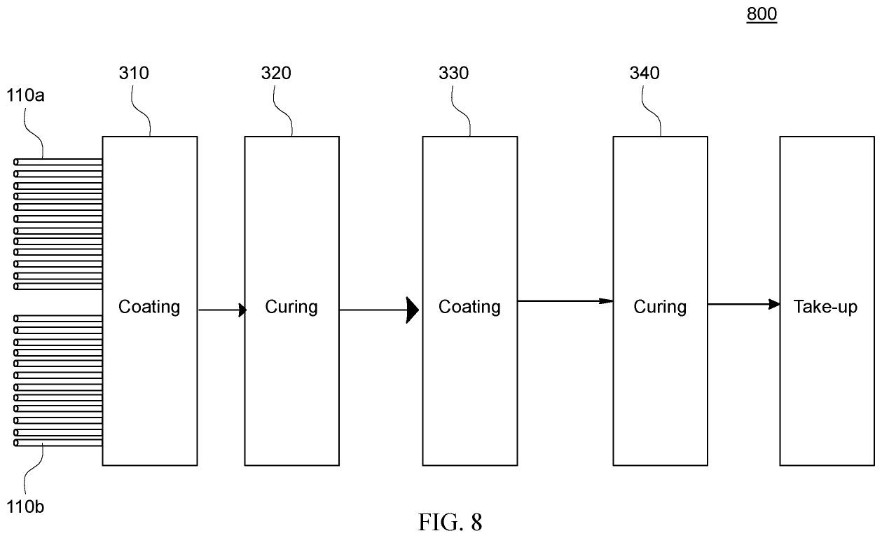

FIG. 8 is a block diagram depicting the method for manufacturing the unitary optical fibre ribbon, in accordance with another embodiment of the present invention. In an exemplary embodiment, the method 800 further comprises disposing (810) a resin coat 110ar, 110br on each set 110a, 110b of the optical fibres 112a, 110b respectively, partially curing (820) the disposed first single resin coat, disposing (830) a second single resin coat 110r on the arranged plurality of sets 110 of the optical fibres 112, and fully curing (240b) the disposed resin coat on the arranged plurality of sets 110 of the optical fibres 112 to form the unitary ribbon 100. In an embodiment, the second predetermined percentage value is greater than the first predetermined percentage value. The difference is in the range of 5 to 30 percentage points. For example, the second predetermined percentage value is 90-99% and the first predetermined percentage value is 70-85%. In another example, the curing level values may be 70%-95% and 90-99% and preferably 95-97%, respectively. The partial curing of the resin coat 112ar and 112br may facilitate to avoid over-curing of the resin coat 112ar and 112br during second curing step and it also promotes good adhesion to the resin coat 110r of the unitary ribbon 100. The subsequent disposing of resin coat (110r) is performed after the partial curing of resin coat (110ar, 110br). The partially cured resin coat (110ar, 110br) helps to achieve a good adhesion with the resin coat (110r). If the the resin coat (110ar, 110br) gets fully cured before disposing of the resin coat (110r), the adhesion between the resin coat (110ar, 110br) and the resin coat (110r) may not be strong.

In an embodiment, the step of curing 240 of the unitary ribbon 100 is performed in two or more stages. A first stage curing is performed before the formation of the split-inducing region 150 and subsequent stage curing is performed after the formation of the split-inducing region 150.

Advantageously, the present invention achieves inline process for unitizing sets of optical fibres which are daughter ribbons using the single same resin/matrix material. Further, the invention provides a process of manufacturing a unitized ribbon by optimizing the chamber environment and curing levels to enable clean splitting of ribbon into desired number of sub-ribbons.

The splitting force between the sets of the optical fibres or the group of individual ribbons is controlled by the mechanical properties of the bonding matrix, the adhesive bonds between the joining material and each individual ribbons and the method of applying the load for the splitting.

Besides, the invention increases process efficiency, product outputs, and logistics, and also allows for improved individual ribbon breakout for mid-span access without specific technique or special tool requirements. The encapsulated ribbon of this invention, which is produced in the form of single Unitized ribbon module, has similar geometrical characteristics to the conventional method in discontinued manufacturing process, although, the aforementioned proposed solutions is given controlled breakout with advantage of easy strip into individual group of fibre or multiple groups of fibres from the unitized ribbon group for the Mid-span access during the cable installation.

While the above detailed description has shown, described, and pointed out novel features as applied to various implementations, it can be understood that various omissions, substitutions, and changes in the form and details of the devices or algorithms illustrated can be made without departing from the scope of the disclosure. As can be recognized, certain implementations described herein can be embodied within a form that does not provide all of the features and benefits set forth herein, as some features can be used or practiced separately from others.

The foregoing description of the specific implementations will so fully reveal the general nature of the implementations herein that others can, by applying current knowledge, readily modify and/or adapt for various applications such specific implementations without departing from the generic concept, and, therefore, such adaptations and modifications should and are intended to be comprehended within the meaning and range of equivalents of the disclosed implementations. It is to be understood that the phraseology or terminology employed herein is for the purpose of description and not of limitation. Therefore, while the implementations herein have been described in terms of preferred implementations, those skilled in the art will recognize that the implementations herein can be practiced with modification within the spirit and scope of the invention as described herein.

1. A method for manufacturing a unitary optical fibre ribbon, the method comprising:
a. Arranging a plurality of sets of optical fibres in a plane, each of the plurality of sets having a plurality of optical fibres held together by a resin coat;
b. subsequently disposing a resin coat over the resin coat on the plurality of sets of optical fibres;
c. forming at least one split-inducing region between adjacent pairs of sets of optical fibres; and
d. curing the resin coat thereby forming a unitary optical fibre ribbon.

2. The method of manufacturing the unitary optical fibre ribbon as claimed in claim 1 comprising, prior to arranging the plurality of sets:
a. arranging a plurality of optical fibres in a plane in a substantially parallel manner;
b. disposing the resin coat on plurality of optical fibres to form multiple sets of optical fibers such that distance between adjacent optical fibers within a set is defined by a ribbon pitch; and
c. partially curing the resin coat to form the plurality of sets

3. The method of manufacturing the optical fibre ribbon as claimed in claim 1, where steps of partially curing the resin coat to form the plurality of sets and substantially fully curing the resin coat to form the unitary optical fibre ribbon are separated by a time gap of between 0.12 to 1.2 seconds.

4. The method of manufacturing the optical fibre ribbon as claimed in claim 1, where arranging a plurality of sets of optical fibres comprising arranging plurality of sets of optical fibres in a plane such that distance between edge optical fibers of adjacent sets of optical fibres is defined by a set pitch, where set pitch is greater than the ribbon pitch by at least 5% of the diameter of the optical fibers,

5. The method of manufacturing the unitary optical fibre ribbon as claimed in claim 1, where subsequently disposing the resin coat on the plurality of sets of optical fibres comprising sandwiching the plurality of sets between the resin coat.

6. The method of manufacturing the unitary ribbon as claimed in claim 1, wherein subsequently disposing the resin coat on the plurality of sets of optical fibres comprises reducing thickness of the resin coat along length of the unitary ribbon at the at least one split-inducing region.

7. The method of manufacturing the optical fibre ribbon as claimed in claim 1, wherein the step of disposing comprises forming one or more grooves between the at least one of pairs of adjacent sets of optical fibres, where the one or more grooves at least partially extend along length of the unitary ribbon 100, having a penetration depth of 60-200 microns and radius of curvature in the range of 0.01-0.04 mm.

8. The method of manufacturing the optical fibre ribbon as claimed in claim 1, wherein the step of curing comprising:
a. curing the resin coat to a second predetermined percentage value, the resin coat being a portion of the resin coat over two or more pairs of adjacent sets of optical fibres in the plurality of the sets of optical fibres; and
b. curing a resin coat layer to a first predetermined percentage value, the resin coat portion being a portion of the resin coat over the each set of plurality of optical fibers.
wherein the second predetermined percentage value is greater than the first predetermined percentage value, the difference being in the range of 5 to 30 percentage points.

9. The method of manufacturing the optical fibre ribbon as claimed in claim 1, wherein the step of curing is performed by providing an environment of the heterogeneous controlled gas mixture with Oxygen in the range of 1000-2000 ppm.

10. The method of manufacturing the optical fibre ribbon as claimed in claim 1, where the resin coat to make the plurality of optical fibers sets of the optical fibers and the resin coat to make the optical fiber ribbon have identical composition.
